(19) United States
(12) Patent Application Publication
(10) Pub. No.: US 2007/0033076 A1
(43) Pub. Date: Feb. 8, 2007

(54) Vehicle value insurance system and method

(76) Inventor: Darius Akbar Sadeghi, Carmel, CA (US)

Correspondence Address: EDWARD S. WRIGHT, 1100 ALMA STREET, SUITE 207, MENLO PARK, CA, 94025, US

(21) Appl. No.: 11/278,865

(22) Filed: Apr. 6, 2006

Related U.S. Application Data
(60) Provisional application No. 60/668,802, filed on Apr. 7, 2005.

(51) Int. Cl. G06Q 40/00; G06F 17/00

(52) U.S. Cl. 705/4; 705/400

(57) ABSTRACT

System and method for insuring the value of a vehicle in which information about the vehicle and the anticipated usage of the vehicle is input, a predicted value for the vehicle is determined from the information about the vehicle and the anticipated usage, a desired term of insurance is input, and the cost of the insurance is calculated from the predicted value of the vehicle and the term of the insurance. At the end of the term, the actual usage of the vehicle is input, the predicted value is updated on the basis of the actual usage, the market value of the vehicle is determined, the updated predicted value is compared with the market value, and a benefit is paid if the updated value is less than the market value.

### RELATED APPLICATION

Provisional Application No. 60/668,802, filed Apr. 7, 2005, the priority of which is claimed.

### BACKGROUND OF THE INVENTION

1. Field of Invention

This invention pertains generally to insurance and, more particularly, to a system and method of insuring the value of a vehicle against unexpected depreciation.

2. Related Art

Although it is well known that automobile and other vehicles such as airplanes and boats generally depreciate or decline in value with usage, unknown variables can make it difficult to predict exactly what the value of a vehicle will be after a given period of usage. That value can, for example, be important when the vehicle is sold or traded in on another vehicle.

### OBJECTS AND SUMMARY OF THE INVENTION

It is, in general, an object of the invention to provide a new and improved system and method for protecting the owner of a vehicle from an unexpected decrease in the value of the vehicle.

Another object of the invention is to provide a system and method of the above character which a vehicle is insured against an unexpected decline in value.

These and other objects are achieved in accordance with the invention by providing a system and method for insuring the value of a vehicle in which information about the vehicle and the anticipated usage of the vehicle is input, a predicted value for the vehicle is determined from the information about the vehicle and the anticipated usage, a desired term of insurance is input, and the cost of the insurance is calculated from the predicted value of the vehicle and the term of the insurance. At the end of the term of the insurance, the actual usage of the vehicle is input, the predicted value is updated on the basis of the actual usage, the market value of the vehicle is determined, the updated predicted value is compared with the market value, and a benefit is paid if the updated value is less than the market value.

### BRIEF DESCRIPTION OF THE DRAWINGS

FIG. 1 is a block diagram of one embodiment of a system for insuring the value of a vehicle against unexpected depreciation in accordance with the invention.

FIGS. 2 and 3 are flow charts illustrating one embodiment of a method for insuring the value of a vehicle against unexpected depreciation in accordance with the invention.

### DETAILED DESCRIPTION

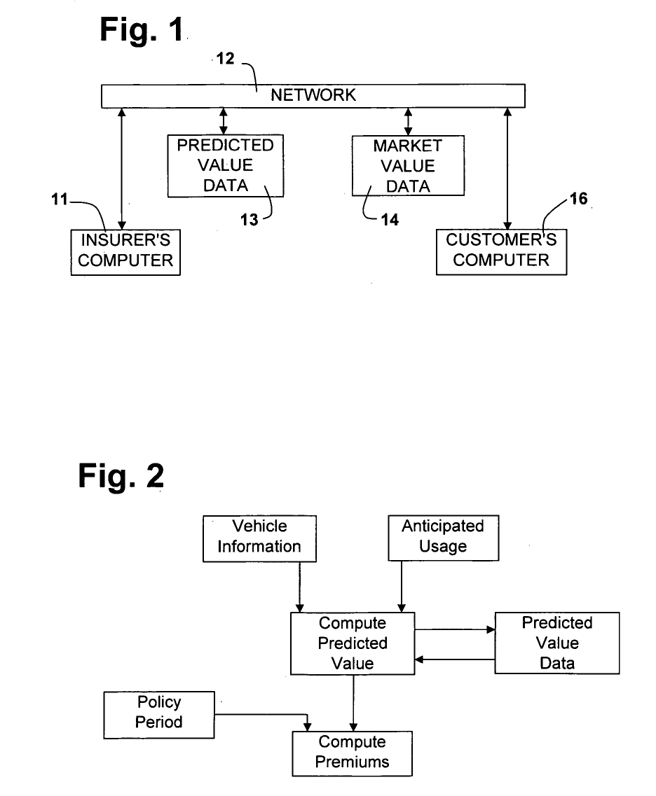

In the embodiment illustrated in FIG. 1, the company or broker issuing the insurance has a computer 11 which is connected to a network 12. The computer is of conventional design and includes suitable input, storage, processing and display devices. The network can be either a wide area network or a local area network, and in the presently preferred embodiment comprises a world wide network of computers commonly known as the Internet.

The system also includes a source of data 13 for the predicted values of automobiles or other types of vehicles. Such data is currently available for the purpose of determining the residual value of automobiles at the end of closed-end leases, and two widely used sources of such data are the Automotive Lease Guide and the Jack Gillis Car Guide. These sources include sophisticated algorithms and mathematical formulas which operate on a large number of variables in determining the predicted value.

The system also includes a source of data 14 for the current market values of vehicles. Such sources are available commercially, with two of the best known ones being the Kelly Blue Book and the National Automobile Dealer's Association Guide.

In the embodiment of FIG. 1, the predicted value data and the market value data are illustrated as being available on the network, although either or both of them can be stored locally or in the insurer's computer, if desired.

Customers can contact the insurer or broker via computers 16 connected to the network or by other suitable means such as in writing, by telephone, or in person. As used herein, the term customer is used broadly and includes anyone who might be interested in purchasing the insurance including, but not limited to, current vehicle owners, individuals or companies who are buying either new or used vehicles, and dealers who might want to purchase such coverage on behalf of their customers as a competitive sales tool.

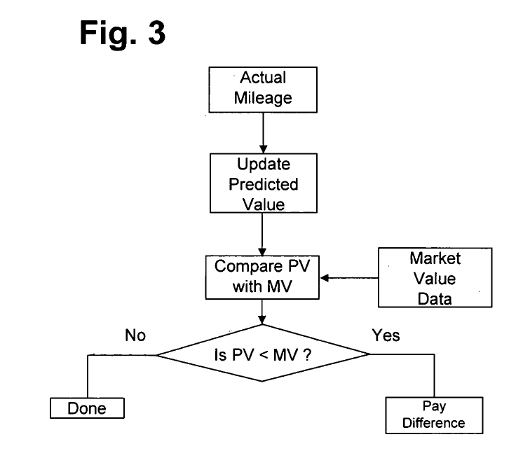

As illustrated in FIG. 2, information about the vehicle to be insured and its anticipated usage is input to the insurer's computer. The information about the vehicle can, for example, include the make, model, year and condition of an automobile, plus additional information such as optional equipment and accessories the vehicle may have. Usage can, for example, include the mileage a car is expected to be driven or, in the case of another type of vehicle such as an airplane or a boat, the number of hours of the vehicle is expected to be operated.

If the customer is communicating with the insurer's computer via the network, the information about the vehicle and its usage can be input by the customer in response to inquiries by the insurer's computer. If the information is provided orally or in writing, it can be input locally into the insurer's computer.

Once the insurer's computer has the information about the vehicle and the anticipated usage, it accesses the predicted value data and determines the predicted value of the vehicle.

Unless it has been done already, the customer is then asked for the policy period or term of insurance he wants, and that information is input to the insurer's computer. That can be done in the same manner that the information about the vehicle and the usage of the vehicle is input either, i.e., via the customer's computer and the network or directly into the insurer's computer. The cost of the insurance or premium for the policy is then calculated from the predicted value of the vehicle and the term of the insurance.

Referring now to FIG. 3, at the end of the policy period or term of protection, the actual mileage or usage is requested and input, and the predicted value is recalculated or updated on the basis of the actual usage rather than the anticipated usage.

The insurer's computer then accesses the current market value data, and the updated predicted value is then compared with the current market value of the vehicle. If the predicted value is equal to or greater than the market value, then no benefit or other payment is due to the insured. If, however, the predicted value is less than the market value, then a benefit in an amount corresponding to the difference between the market value and the predicted value is due and is paid to the insured.

The invention has a number of important features and advantages. It guarantees the owner or buyer of an automobile or other vehicle that the value of the vehicle will be at least a certain amount at the end of the term for which the value of the vehicle is insured, thereby protecting him against and unexpected and unknown declined in the value of the vehicle. In addition to protecting the owner financially, having the value of the vehicle protected can also avoid the need to negotiate the price of the vehicle when the vehicle is sold, traded in, or otherwise disposed of.

It is apparent from the foregoing that a new and improved system and method for insuring the value of a vehicle against unexpected depreciation have been provided. While only certain presently preferred embodiments have been described in detail, as will be apparent to those familiar with the art, certain changes and modifications can be made without departing from the scope of the invention as defined by the following claims.

1. A system for insuring the value of a vehicle, comprising: means for inputting information about the vehicle and the anticipated mileage the vehicle is to be driven, means for determining a predicted value for the vehicle based upon the information about the vehicle and the anticipated mileage, means for inputting a desired term of insurance, means for computing the cost of the insurance from the predicted value of the vehicle and the term of the insurance, means for inputting the actual mileage the vehicle was driven at the end of the term of the insurance, means for updating the predicted value of the vehicle based upon the actual mileage rather than the anticipated mileage, means for determining the market value of the vehicle at the end of the term of the insurance, and means for comparing the updated predicted value with the market value, with a benefit being due if the updated value is less than the market value.

2. The system of claim 1 wherein the means for inputting information about the vehicle includes means for inputting the make, model and year of the vehicle.

3. A system for insuring the value of a vehicle and paying a benefit if a predicted value of the vehicle is less than the market value of the vehicle at the end of a term of insurance.

4. The system of claim 3 including means for inputting information about the vehicle and the anticipated mileage the vehicle is to be driven, means for determining the predicted value of the vehicle based upon the information about the vehicle and the anticipated mileage, means for inputting a desired term of insurance, and means for computing the cost of the insurance from the predicted value of the vehicle and the term of the insurance.

5. The system of claim 4 wherein the means for inputting information about the vehicle includes means for inputting the make, model and year of the vehicle.

6. The system of claim 4 including means for determining the market value of the vehicle at the end of the term of the insurance, and means for comparing the predicted value with the market value to determine if a benefit is due.

7. The system of claim 6 including means for inputting the actual mileage the vehicle was driven at the end of the term of the insurance, and means for updating the predicted value of the vehicle based upon the actual mileage rather than the anticipated mileage, with the updated value being compared with the market value to determine if a benefit is due.

8. A system for insuring the value of a vehicle, comprising: means for inputting information about the vehicle and the anticipated usage of the vehicle, means for determining a predicted value for the vehicle based upon the information about the vehicle and the anticipated usage, means for inputting a desired term of insurance, means for computing the cost of the insurance from the predicted value of the vehicle and the term of the insurance, means for inputting the actual usage of the vehicle at the end of the term of the insurance, means for determining the market value of the vehicle at the end of the term of the insurance, and means for comparing the predicted value with the market value, with a benefit being due if the predicted value is less than the market value.

9. The system of claim 8 including means for updating the predicted value of the vehicle at the end of the term based upon actual usage rather than the anticipated usage, with the updated value being compared with the market value to determine if a benefit is due.

10. A method of insuring the value of a vehicle, comprising the steps of: inputting information about the vehicle and the anticipated mileage the vehicle is to be driven, determining a predicted value for the vehicle based upon the information about the vehicle and the anticipated mileage, inputting a desired term of insurance, computing the cost of the insurance from the predicted value of the vehicle and the term of the insurance, inputting the actual mileage the vehicle was driven at the end of the term of the insurance, updating the predicted value of the vehicle based upon the actual mileage rather than the anticipated mileage, determining the market value of the vehicle at the end of the term of the insurance, and comparing the updated predicted value with the market value, with a benefit being due if the updated value is less than the market value.

11. The method of claim 10 wherein the information input about the vehicle includes the make, model and year of the vehicle.

12. A method of insuring the value of a vehicle and paying a benefit if a predicted value of the vehicle is less than the market value of the vehicle at the end of a term of insurance.

13. The method of claim 12 including the steps of inputting information about the vehicle and the anticipated mileage the vehicle is to be driven, determining the predicted value of the vehicle based upon the information about the vehicle and the anticipated mileage, inputting a desired term of insurance, and computing the cost of the insurance from the predicted value of the vehicle and the term of the insurance.

14. The method of claim 13 wherein the information input about the vehicle includes the make, model and year of the vehicle.

15. The method of claim 12 including the steps of determining the market value of the vehicle at the end of the term of the insurance, and comparing the predicted value with the market value to determine if a benefit is due.

16. The method of claim 15 including the steps of inputting the actual mileage the vehicle was driven at the end of the term of the insurance, and updating the predicted value of the vehicle based upon the actual mileage rather than the anticipated mileage, with the updated value being compared with the market value to determine if a benefit is due.

17. A method of insuring the value of a vehicle, comprising the steps of: inputting information about the vehicle and the anticipated usage of the vehicle, determining a predicted value for the vehicle based upon the information about the vehicle and the anticipated usage, inputting a desired term of insurance, computing the cost of the insurance from the predicted value of the vehicle and the term of the insurance, inputting the actual usage of the vehicle at the end of the term of the insurance, determining the market value of the vehicle at the end of the term of the insurance, and comparing the predicted value with the market value, with a benefit being due if the predicted value is less than the market value.

18. The method of claim 17 including the steps of updating the predicted value of the vehicle at the end of the term based upon actual usage rather than the anticipated usage, with the updated value being compared with the market value to determine if a benefit is due.
